(19) United States
(12) Patent Application Publication
(10) Pub. No.: US 2006/0137746 A1
(43) Pub. Date: Jun. 29, 2006

(54) Pressure regulation apparatus

(76) Inventors: Katsuya Maita, Iwate-gun (JP); Takuya Terui, Iwate-gun (JP)

Correspondence Address: HARNESS, DICKEY & PIERCE, P.L.C., P.O. BOX 8910, RESTON, VA, 20195, US

(21) Appl. No.: 11/312,641

(22) Filed: Dec. 21, 2005

(30) Foreign Application Priority Data
Dec. 24, 2004 (JP) 2004-372776

(51) Int. Cl. F16K 31/36

(52) U.S. Cl. 137/510

(57) ABSTRACT

An object of the present invention is to obtain a pressure regulation apparatus in a return-less fuel supply system, which can prevent fuel leakage into an engine when the air tightness of an injector valve decreases. A valve is provided on a diaphragm which is urged toward an inlet portion. A rod is provided in the center of the valve. The rod is inserted into a passage which communicates with the inlet portion. A ball valve which is urged in the direction of the rod is disposed inside the inlet portion. When the valve is pushed against a side wall on the inlet portion side, the valve closes and the rod extends into the inlet portion, thereby opening the ball valve. When the pressure of fuel passing through a gap between the rod and passage exceeds a valve-opening pressure of the valve, the valve opens and fuel is supplied into a pressure regulation chamber. When the internal pressure of the pressure regulation chamber reaches an upper pressure limit, the rod is caused to retreat by pressure acting on the diaphragm. As a result, the ball valve closes and the internal pressure of the pressure regulation chamber falls.

### PRIORITY STATEMENT

This application claims benefit of Japanese Patent Application No. 2004-372776, filed on Dec. 24, 2004, in the Japanese Intellectual Property Office, the disclosure of which is incorporated herein in its entirety by reference.

### BACKGROUND OF THE INVENTION

1. Field of the Invention

The present invention relates to a pressure regulation apparatus provided on the downstream side of a pump, and more particularly to a pressure regulation apparatus for regulating fuel pressure from a pump in a fuel supply system for supplying liquid fuel from a fuel tank to an injector via the pump.

2. Description of the Related Art

In a fuel supply system for supplying fuel to an internal combustion engine, for example, fuel is supplied from a fuel tank to an injector via a fuel pump. A pressure regulation apparatus for regulating the fuel pressure is provided between the fuel pump and the injector. In a return-less fuel supply system, an inlet control-type pressure regulation apparatus, for example, is used (see Japanese Unexamined Patent Application Publication 2001-289341 and Japanese Unexamined Patent Application Publication H07-217517).

In an inlet control-type pressure regulation apparatus, when the internal pressure of the pressure regulation apparatus rises above a set pressure (an upper pressure limit input into the injector), a valve provided at an inlet of the pressure regulation apparatus is closed by a diaphragm which operates in accordance with pressure variation. When the internal pressure of the pressure regulation apparatus falls below the set pressure as fuel is injected by the injector, the valve is opened.

In other words, in a conventional pressure regulation apparatus, when the internal pressure of the pressure regulation apparatus is lower than the set pressure, the inlet valve is opened such that the upstream side and downstream side of the pressure regulation apparatus are fluidically connected. Hence, in such cases, the pressure on the upstream side of the pressure regulation apparatus also acts on the downstream side.

Meanwhile, the injector provided on the downstream side of the pressure regulation apparatus typically comprises a function for blocking the flow hermetically during inoperative periods, and is capable of maintaining residual pressure between the fuel pump and injector when the fuel pump is stopped. However, the air tightness is not necessarily sufficient at all times, and may decrease due to deterioration of the valve, trapped foreign matter, and so on. In such cases, the injector cannot maintain the residual pressure.

In particular, when the internal pressure or pressure head of the fuel tank acts on the injector via the pressure regulation apparatus, the fuel may leak into the engine side. One method of solving this problem is to provide a fuel cock between the fuel tank and fuel pump, but this leads to an increase in the number of components, and is also disadvantageous in terms of space utilization and operability.

### SUMMARY OF THE INVENTION

An object of the present invention is to provide a pressure regulation apparatus which can prevent fuel leakage into an engine when the air tightness of an injector valve decreases.

A pressure regulation apparatus of the present invention regulates pressure from a pump provided on an upstream side, and comprises: a first blocking mechanism for blocking a flow until the pressure from the upstream side reaches a first pressure; and a second blocking mechanism for blocking the flow when the pressure from the upstream side reaches a second pressure. The first pressure, the second pressure, a residual pressure generated on the upstream side when the pump is inoperative, and a discharge pressure of the pump have a relationship of residual pressure<first pressure<second pressure<discharge pressure.

The pressure regulation apparatus further comprises an inlet portion connected to the upstream side, and a pressure regulation chamber connected to the inlet portion via a passage. The first blocking mechanism is operated by a diaphragm provided in the pressure regulation chamber. At this time, the second blocking mechanism comprises the diaphragm, a valve provided at an inlet to the passage, a rod member provided on the diaphragm and inserted into the passage, and pushing means for pushing the diaphragm toward the pressure regulation chamber. When the diaphragm moves toward the pressure regulation chamber, the rod member advances toward the valve, thereby opening the valve, and when the diaphragm moves toward the pushing means, the rod member retreats, thereby closing the valve.

Further, the first blocking mechanism comprises a valve such that when the diaphragm is moved to a maximum limit toward the pressure regulation chamber, the valve blocks the flow from the passage to the pressure regulation chamber. At this time, the valve comprises a pressure receiving surface for receiving pressure from the inlet portion, which passes through a gap between the passage and the rod member. The surface area of the pressure receiving surface is greater than an effective pressure receiving surface area of the diaphragm. The valve also comprises a sealing member for hermetically sealing the passage and pressure regulation chamber from each other, and the sealing member is preferably constituted by an elastic member.

According to the present invention as described above, a pressure regulation apparatus which is capable of preventing fuel leakage into an engine when the air tightness of an injector valve decreases can be provided.

### BRIEF DESCRIPTION OF THE DRAWINGS

FIG. 1 is a block diagram showing an outline of a fuel supply system which uses a pressure regulation apparatus serving as an embodiment of the present invention;

FIG. 2 is a schematic sectional view of the pressure regulation apparatus of this embodiment;

FIG. 3 shows the pressure regulation apparatus when a valve is slightly open; and

FIG. 4 shows the pressure regulation apparatus when the valve is fully open and a ball valve is closed.

### DESCRIPTION OF THE PREFERRED EMBODIMENTS

An embodiment of the present invention will now be described with reference to the drawings.

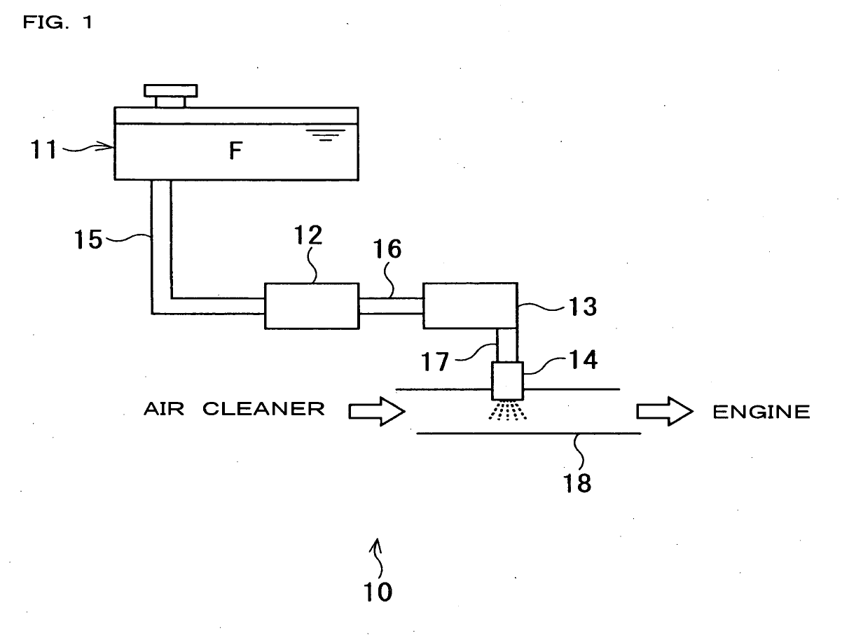

FIG. 1 is a pattern diagram showing an outline of a fuel supply system which uses a pressure regulation apparatus serving as an embodiment of the present invention.

A fuel supply system 10 is principally constituted by a fuel tank 11, a fuel pump 12, a pressure regulation apparatus 13, and an injector 14. Liquid fuel F stored in the fuel tank 11 is led to the fuel pump 12 through a pipe 15. The fuel F is then supplied to the pressure regulation apparatus 13 through a pipe 16 at a predetermined discharge pressure Pd.

In the pressure regulation apparatus 13, the fuel pressure is regulated using a method to be described below, whereupon the fuel F is supplied to the injector 14 via a pipe 17. Then, at a predetermined timing, the fuel F is injected through the injector 14 into an intake pipe 18 of an engine (not shown), where the fuel F is mixed with air taken in through an air cleaner (not shown).

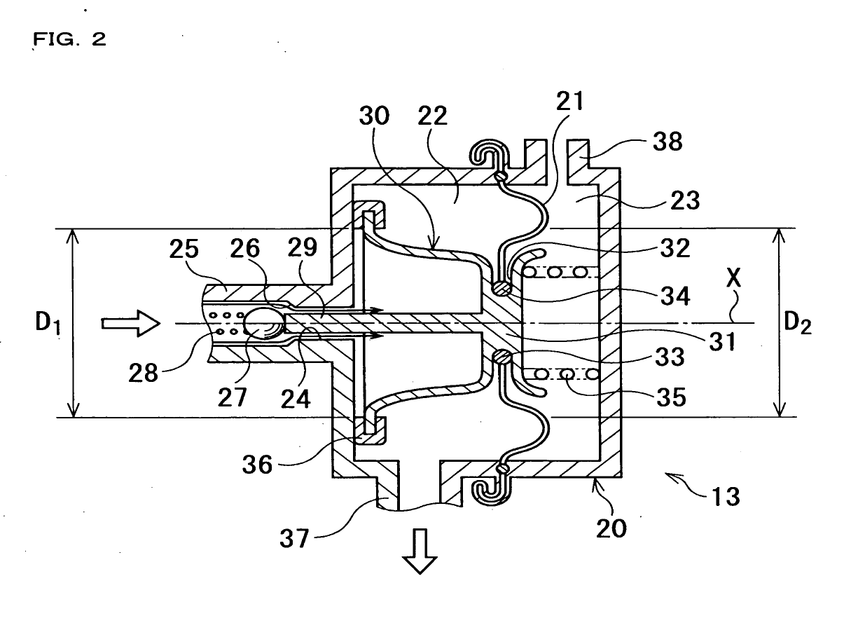

FIG. 2 is a schematic sectional view of the pressure regulation apparatus 13 of this embodiment. The structure of the pressure regulation apparatus 13 of this embodiment will now be described with reference to FIG. 2.

A pressure regulation chamber 22 and a diaphragm chamber 23 are hermetically separated by a diaphragm 21 within a casing 20 of the pressure regulation apparatus 13. A cylindrical passage 24 is formed coaxially with a central axis X of the diaphragm 21 on a side wall of the pressure regulation chamber 22. The passage 24 connects an inlet portion 25 connected to the pipe 16 and the pressure regulation chamber 22 to each other. The inlet portion 25 takes a cylindrical form which is coaxial with the passage 24. The inner diameter of the inlet portion 25 is slightly larger than the inner diameter of the passage 24, and a connection portion 26 connecting the inlet portion 25 and passage 24 takes a tapered form.

A ball valve 27 is incorporated into the inlet portion 25 and urged toward the passage 24 side by a spring 28 serving as energizing means. The outer diameter of the ball valve 27 is set to allow the liquid fuel F to flow through a gap between the ball valve 27 and the inner wall of the inlet portion 25. In other words, when the ball valve 27 is moved along the axis X in the direction of the connection portion 26 by the energizing force of the spring 28 and abuts against the connection portion 26, communication between the inlet portion 25 and passage 24 is blocked hermetically. Note that the spring 28 is supported in the inlet portion 25 by a constitution not shown in the drawing.

The ball valve 27 is supported by a tip end of a rod 29 from the opposite side to the spring 28. The rod 29 is inserted into the passage 24 along the axis X. The other end of the rod 29 is connected to a valve 30 supported by the diaphragm 21, and hence the rod 29 moves integrally with the valve 30. Note that the outer diameter of the rod 29 is slightly smaller than the inner diameter of the passage 24 so that a gap through which the liquid fuel F can flow is formed between the rod 29 and passage 24.

In this embodiment, the valve 30 is formed in a cup form, for example, and the rod 29 extends from a central inside portion of the cup-form valve 30 beyond an opening portion of the cup. The cup-form valve 30 is disposed such that its opening faces the side wall of the pressure regulation chamber 22 in which the passage 24 is formed, and thus the rod 29 is inserted into the passage 24. In other words, the valve 30 is disposed coaxially with the axis X.

A promontory portion 31 provided on the bottom surface of the valve 30 comprises an arc portion 32, for example, and a central opening portion of the diaphragm 21 is attached hermetically to the arc portion 32 via a sealing member 33. More specifically, a bottom surface 34 of the promontory portion 31 is disposed inside the diaphragm chamber 23 via the central opening portion of the diaphragm 21, and engaged with a spring 35 provided inside the diaphragm chamber 23 to serve as energizing means. Note that a vent 38 for regulating the internal pressure of the diaphragm chamber 23 is provided in a wall surface surrounding the diaphragm chamber 23.

The spring 35 pushes the valve 30 toward the inlet portion 25 side along the axis X, and an outer peripheral edge portion of the diaphragm 21 which supports the valve 30 is attached hermetically to the casing 20. Further, a sealing member 36 constituted by an elastic member made of rubber, for example, is attached to a peripheral edge portion of the opening portion of the cup-form valve 30.

By means of the constitution described above, the valve 30 and rod 29 are capable of integral movement along the axis X. Note that an outlet portion 37 for supplying the liquid fuel F that flows into the pressure regulation chamber 22 through the passage 24 to the injector 14 is provided in the pressure regulation chamber 22, and this outlet portion 37 is connected to the pipe 17.

Next, an operation of the pressure regulation apparatus 13 will be described with reference to FIGS. 1 to 4.

FIG. 2 shows a state in which the valve 30 is pushed against the side wall in which the passage 24 is formed. The valve 30 is in a position of maximum movement toward the inlet portion 25 side. In other words, the sealing member 36 provided on the peripheral edge of the valve 30 is in close contact with the side wall such that the inside and outside of the valve 30 are hermetically sealed from each other. Furthermore, the tip end portion of the rod 29 is pushing the ball valve 27 against the spring 28 such that the ball valve 27 is removed from the connection portion 26.

Here, the ball valve 27 is open, and therefore the fuel pressure on the upstream side of the inlet portion 25 is transmitted into the valve 30 through the passage 24. Meanwhile, the inside and outside of the valve 30 are hermetically partitioned by the sealing member 36, and therefore the fuel F does not leak into the pressure regulation chamber 22.

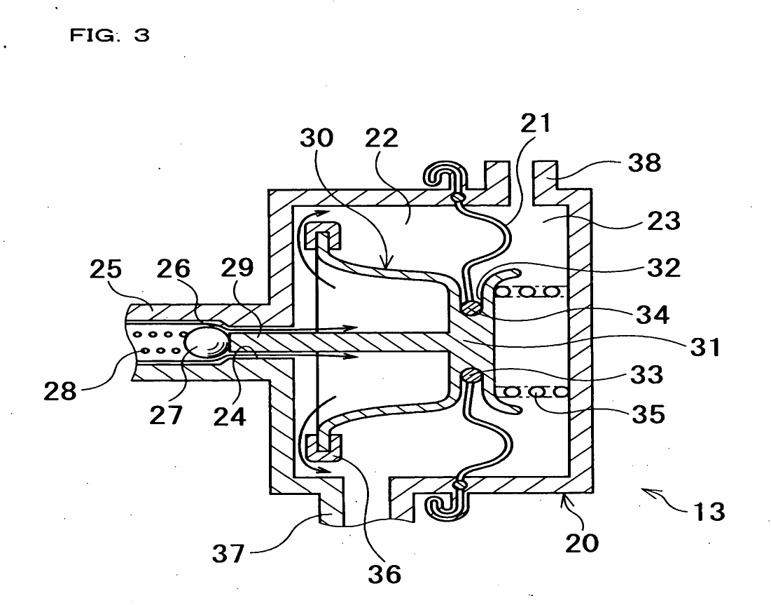

Since the ball valve 27 is open, the liquid fuel F in the valve 30 applies the pressure from the upstream side of the inlet portion 25 to the inner wall surface of the valve 30. As a result, the fuel pressure reaches a fixed valve-opening pressure (first pressure). When the force received on the pressure receiving surface of the valve 30 increases beyond the spring force (valve-opening force) of the spring 35 when the valve 30 is in a closed position, the valve 30 moves in the rightward direction of the drawing while compressing the spring 35 until the spring force is counterbalanced. In other words, the valve 30 blocks the flow until the upstream side pressure matches the valve-opening pressure. Note that at this time, the rod 29 retreats from the inlet portion 25 such that the ball valve 27 moves toward the connection portion 26 connecting the inlet portion 25 and passage 24. FIG. 3 shows a state in which the valve 30 is slightly open.

In FIG. 3, the valve 30 is slightly removed from the side wall, and is therefore open, while the ball valve 27 is not yet closed. Hence, the liquid fuel F is capable of flowing into the valve 30 through the gap between the passage 24 and rod 29, and also capable of flowing into the pressure regulation chamber 22. As a result, the internal pressure of the pressure regulation chamber 22 becomes substantially equal to the pressure on the upstream side of the inlet portion 25. In other words, a substantially equal pressure to the pressure on the upstream side of the inlet portion 25 acts on the pressure receiving surface of the diaphragm 21.

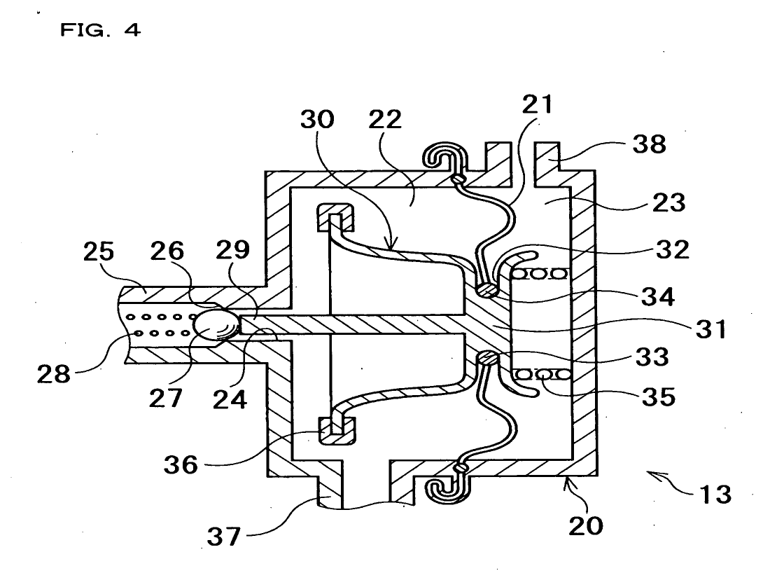

When the internal pressure of the pressure regulating chamber 22 rises further, the valve 30 and rod 29 are moved further rightward by the pressure received on the pressure receiving surface of the diaphragm 21, thereby compressing the spring 35. As shown in FIG. 4, when the pressure reaches a predetermined control pressure (for example, an upper pressure limit at which the injector load is not excessive), the tip end of the rod 29 retreats substantially fully from the inlet portion 25 into the passage 24.

When the tip end of the rod 29 retreats substantially fully into the passage 24, the ball valve 27 impinges on the connection portion 26, thereby blocking communication between the inlet portion 25 and passage 24. As a result, supply of the fuel F from the fuel pump 12 is blocked by the ball valve 27. In other words, when the pressure from the upstream side reaches the upper pressure limit, the ball valve 27 blocks the flow. Note that the internal pressure of the pressure regulation chamber 22 falls as the fuel F is transmitted from the pressure regulation chamber 22 to the injector 14.

When the internal pressure of the pressure regulation chamber 22 falls below the upper pressure limit, the valve 30 and rod 29 are moved to the left side of the drawing by the spring force of the spring 35. As a result, the ball valve 27 is reopened by the rod 29, thereby connecting the inlet portion 25 and pressure regulation chamber 22. Accordingly, the internal pressure of the pressure regulation chamber 22 rises again, and the diaphragm 21 compresses the spring 35 again until the ball valve 27 is closed.

The operation described above is repeated while the fuel pump 12 and injector 14 are operative such that the pressure of the pressure regulation chamber 22 (i.e. on the downstream side of the pressure regulation apparatus 13) is maintained within a fixed range having the aforementioned predetermined control pressure as an upper limit.

When the engine is stopped such that the fuel pump 12 becomes inoperative, the fuel pressure from the fuel pump 12 falls, and hence the internal pressure of the pressure regulation chamber 22 falls further, without recovering, even if the ball valve 27 opens. When the pressure received by the diaphragm 21 falls below the valve-opening pressure, the valve 30 impinges on the side wall again, and communication between the inlet portion 25 and pressure regulation chamber 22 is blocked by the valve 30.

According to this embodiment, as described above, when the fuel pump 12 is stopped, the valve 30 prevents the fuel F from flowing into the pressure regulation apparatus 13, and hence the valve 30 can prevent the fuel F from leaking into the engine even when the sealing function of the injector 14 deteriorates.

Hence, when the fuel pump (i.e. the engine) is inoperative, the valve-opening pressure of the valve 30 is more necessary than the pressure which acts on the upstream side (the internal pressure, pressure head, and so on of the fuel tank). For example, when the upstream side pressure is 40 kPa, the discharge pressure of the fuel pump is 400 kPa, the valve-opening force of the spring 35 is 6 kg, and the valve-opening pressure is set to approximately 100 kPa, for example, the diameter of the pressure receiving surface of the valve 30 is set to slightly less than approximately 28 mm, for example. Here, the pressure receiving surface area of the valve 30 is set larger than the effective pressure receiving surface area of the diaphragm 21 (diameter D₁ of the valve 30>effective diameter D₂ of the diaphragm 21). Note that the effective pressure receiving surface area corresponds to surface area S=F/P, where P is the pressure acting on the diaphragm and F is the spring force acting on the diaphragm, and the effective diameter D₂ corresponds to a value which satisfies S=π(D₂/2)². Also note that at this time, the upper pressure limit (control pressure) at which the ball valve 27 opens is naturally lower than the discharge pressure (400 kPa) and higher than the valve-opening pressure (100 kPa).

Further, in this embodiment a sealing member constituted by an elastic body is provided on the peripheral edge of the valve, and therefore air tightness can be improved and noise generated as the valve is opened and closed repeatedly can be reduced.

What is claimed is:

1. A pressure regulation apparatus for regulating pressure from a pump provided on an upstream side, comprising:
a first blocking mechanism for blocking a flow until said pressure from said upstream side reaches a first pressure; and
a second blocking mechanism for blocking said flow when said pressure from said upstream side reaches a second pressure,
wherein said first pressure, said second pressure, a residual pressure generated on said upstream side when said pump is inoperative, and a discharge pressure of said pump have a relationship of said residual pressure<said first pressure<said second pressure<said discharge pressure.

2. The pressure regulation apparatus according to claim 1, further comprising:
an inlet portion connected to said upstream side; and
a pressure regulation chamber connected to said inlet portion via a passage,
wherein said first blocking mechanism is operated by a diaphragm provided in said pressure regulation chamber.

3. The pressure regulation apparatus according to claim 2, wherein said second blocking mechanism comprises:
said diaphragm;
a valve provided at an inlet to said passage;
a rod member provided on said diaphragm and inserted into said passage; and
pushing means for pushing said diaphragm toward said pressure regulation chamber, and
when said diaphragm moves toward said pressure regulation chamber, said rod member advances toward said valve, thereby opening said valve, and when said diaphragm moves toward said pushing means, said rod member retreats, thereby closing said valve.

4. The pressure regulation apparatus according to claim 3, wherein said first blocking mechanism comprises a valve, and when said diaphragm is moved to a maximum limit toward said pressure regulation chamber, said valve blocks said flow from said passage into said pressure regulation chamber.

5. The pressure regulation apparatus according to claim 4, wherein said valve has a pressure receiving surface for receiving pressure from said inlet portion, which passes through a gap between said passage and said rod member, and a surface area of said pressure receiving surface is greater than an effective pressure receiving surface area of said diaphragm.

6. The pressure regulation apparatus according to claim 4, wherein said valve comprises a sealing member for hermetically sealing said passage and said pressure regulation chamber from each other, said sealing member being constituted by an elastic member.
